(19) United States
(12) Patent Application Publication
(10) Pub. No.: US 2024/0341349 A1
(43) Pub. Date: Oct. 17, 2024

(54) AEROSOL GENERATING ARTICLE, SYSTEM AND METHOD OF MANUFACTURING AEROSOL GENERATING ARTICLE

(71) Applicant: KT&G CORPORATION, Daejeon (KR)

(72) Inventors: Hee Tae JUNG, Daejeon (KR); Sang Yeon YOO, Seoul (KR); Hwikyeong AN, Seoul (KR); Hee Jeong HONG, Seoul (KR); Da Bin SONG, Daejeon (KR)

(73) Assignee: KT&G CORPORATION, Daejeon (KR)

(21) Appl. No.: 18/034,923

(22) PCT Filed: Jan. 4, 2023
(86) PCT No.: PCT/KR2023/000151

§ 371 Date: May 2, 2023

(30) Foreign Application Priority Data
Jan. 24, 2022 (KR) 10-2022-0009776

(51) Int. Cl. A24D 1/20; A24C 5/01; A24F 40/20; A24F 40/465

(52) U.S. Cl. CPC A24D 1/20; A24C 5/01; A24F 40/20; A24F 40/465

(57) ABSTRACT

An aerosol generating article includes a first segment which includes: a filling material and a susceptor disposed to enclose a portion of the filling material and be enclosed by another portion of the filling material; and a second segment disposed next to the first segment along a lengthwise direction of the aerosol generating article.

### TECHNICAL FIELD

The following embodiments relate to an aerosol generating article, a system, and a method of manufacturing an aerosol generating article.

### BACKGROUND ART

Recently, demands for alternative ways to overcome disadvantages of general aerosol generating articles have increased. For example, there is an increasing demand for a way of generating an aerosol by heating an aerosol generating material in an aerosol generating article rather than by burning an aerosol generating article. Accordingly, research on a heating-type aerosol generating article or a heating-type aerosol generating device is being actively conducted. For example, Korean Patent Publication No. 10-2019-0049396 discloses an aerosol generating device.

### DISCLOSURE OF THE INVENTION

### Technical Goals

An aspect provides an aerosol generating article including a susceptor in a medium to increase a contact area between the susceptor and the medium, thereby improving heating efficiency.

An aspect provides an aerosol generating article by which larger amounts of aerosols are generated as heating efficiency of the aerosol generating article increases.

An aspect provides a method of effectively manufacturing an aerosol generating article including a susceptor in a medium.

### Technical Solutions

According to an aspect, there is provided an aerosol generating article including: a first segment including a filling material and a susceptor disposed to enclose a portion of the filling material and be enclosed by another portion of the filling material; and a second segment disposed next to the first segment along a lengthwise direction of the aerosol generating article.

The susceptor may include an inner surface facing a center of the first segment, and an outer surface opposite to the inner surface.

The susceptor may have a cylindrical shape.

A radius of the cylindrical shape in which the susceptor is formed may be greater than a half of a radius of the first segment and less than the radius of the first segment.

The susceptor may include a first susceptor and a second susceptor, the first susceptor may have a cylindrical shape having a first radius, the second susceptor may have a cylindrical shape having a second radius, and the second radius may be greater than the first radius.

The cylindrical shape of the first susceptor and the cylindrical shape of the second susceptor may be concentric.

The susceptor may further include a third susceptor, the third susceptor may have a cylindrical shape having a third radius, and the third radius may be greater than the second radius.

The filling material may include a medium and a thermally conductive powdered material.

The powdered material may include at least one of aluminum, gold, iron, nickel, cobalt, conductive carbon, graphite, mild steel, stainless steel, copper, and bronze.

The susceptor may include at least one of aluminum, gold, iron, nickel, cobalt, conductive carbon, graphite, mild steel, stainless steel, copper, and bronze.

According to another aspect, there is provided an aerosol generating system including: an aerosol generating article including a first segment including a filling material and a susceptor disposed to enclose a portion of the filling material and be enclosed by another portion of the filling material, and a second segment disposed next to the first segment along a lengthwise direction of the aerosol generating article; and an aerosol generating device including an article insertion portion configured to accommodate the aerosol generating article, a battery, and a coil, wherein the coil may be configured to generate a variable magnetic field by receiving power from the battery, and the susceptor may be configured to generate heat by the variable magnetic field.

According to another aspect, there is provided a method of manufacturing an aerosol generating article, the method including providing the aerosol generating article including a first segment filled with a filling material, providing a susceptor, positioning the susceptor and the aerosol generating article such that the susceptor is aligned with an end of the first segment, and pushing the susceptor into the first segment.

### Effects

According to an embodiment, an aerosol generating article may increase heating efficiency by including a susceptor in a medium to increase a contact area between the susceptor and the medium.

According to an embodiment, an aerosol generating article may generate a large amount of aerosol by increasing heating efficiency of the aerosol generating article.

According to an embodiment, a method of manufacturing an aerosol generating article may provide a method of efficiently manufacturing an aerosol generating article including a susceptor in a medium.

The effects of an aerosol generating device and an aerosol generating system according to an embodiment are not limited to the above-mentioned effects, and other unmentioned effects may be clearly understood from the following description by one of ordinary skill in the art.

### BRIEF DESCRIPTION OF DRAWINGS

FIG. 1 is a block diagram of an aerosol generating device according to an embodiment.

FIG. 2 is a schematic diagram of an aerosol generating article according to an embodiment.

FIGS. 3A and 3B are diagrams schematically illustrating an aerosol generating article according to an embodiment.

FIGS. 4A and 4B are diagrams schematically illustrating an aerosol generating article according to another embodiment.

FIG. 5 is a diagram schematically illustrating an aerosol generating system according to an embodiment.

FIG. 6 is a flow chart of a method of manufacturing an aerosol generating article according to an embodiment.

FIG. 7 is a flow chart of a method of manufacturing an aerosol generating article according to another embodiment.

### BEST MODE FOR CARRYING OUT THE INVENTION

The terms used to describe the embodiments are selected from among common terms that are currently widely used, in consideration of their function in the disclosure. However, different terms may be used depending on an intention of one of ordinary skill in the art, a precedent, or the advent of new technology. Also, in particular cases, the terms are discretionally selected by the applicant of the disclosure, and the meaning of those terms will be described in detail in the corresponding part of the detailed description. Therefore, the terms used to describe the disclosure should be defined not by the simple names of the terms but by the meanings of the terms and content throughout the disclosure.

It will be understood that when a certain part “includes” a certain component, the part does not exclude another component but may further include another component, unless the context clearly dictates otherwise. Also, terms such as “unit,” “module,” etc., as used in the specification may refer to a part for processing at least one function or operation and which may be implemented as hardware, software, or a combination of hardware and software.

As used herein, an expression such as “at least one of” that precedes listed components modifies not each of the listed components but all the listed components. For example, the expression “at least one of a, b, or c” should be construed as including a, b, c, a and b, a and c, b and c, or a, b, and c.

In following descriptions of embodiments, the term “aerosol generating article” may refer to an article that accommodates a medium, in which an aerosol passes through the article and the medium is transferred. A representative example of the aerosol generating article may be a cigarette. However, the scope of the disclosure is not limited thereto.

In following descriptions of embodiments, the terms “upstream” or “upstream direction” may refer to a direction away from a mouth of a user (smoker), and the terms “downstream” or “downstream direction” may refer to a direction toward the mouth of the user. The terms “upstream” and “downstream” may be used to describe relative positions of components of the aerosol generating article.

In following descriptions of embodiments, the term “puff” may refer to inhalation by the user, in a situation in which an aerosol is sucked into the mouth, nose, or lungs of the user through the mouth or nose of the user.

In an embodiment, an aerosol generating device may be a device that generates an aerosol by electrically heating an aerosol generating article accommodated in an inner space.

The aerosol generating device may include a heater. In an embodiment, the heater may be an electrically resistive heater. For example, the heater may include an electrically conductive track, and the heater may be heated as a current flows through the electrically conductive track.

The heater may include a tubular heating element, a plate-shaped heating element, a needle-shaped heating element, or a rod-shaped heating element, and may heat the inside or outside of the aerosol generating article according to the shape of a heating element.

The aerosol generating article may include a first segment and a second segment. The first segment may be formed as a sheet or a strand, or may be formed of tobacco leaves finely cut from a tobacco sheet. In addition, the first segment may be enveloped by a thermally conductive material. For example, the thermally conductive material may be a metal foil such as an aluminum foil. However, embodiments are not limited thereto.

The second segment may be a cellulose acetate filter. The second segment may include at least one segment. For example, the second segment may include a first segment that cools an aerosol and a second segment that filters a predetermined ingredient contained in the aerosol.

In another embodiment, the aerosol generating device may be a device that generates an aerosol using a cartridge containing an aerosol generating material.

The aerosol generating device may include a cartridge containing the aerosol generating material and a main body supporting the cartridge. The cartridge may be detachably coupled to the main body. However, embodiments are not limited thereto. The cartridge may be integrally formed or assembled with the main body, and may be secured to the main body so as not to be detached by a user. The cartridge may be mounted on the main body while the aerosol generating material is accommodated therein. However, embodiments are not limited thereto. The aerosol generating material may be injected into the cartridge while the cartridge is coupled to the main body.

The cartridge may hold the aerosol generating material in any one of various states, such as a liquid state, a solid state, a gaseous state, and a gel state. The aerosol generating material may include a liquid composition. For example, the liquid composition may be a liquid including a tobacco-containing material having a volatile tobacco flavor ingredient, or a liquid including a non-tobacco material.

The cartridge may be operated by an electrical signal or a wireless signal transmitted from the main body to perform the function of generating an aerosol by converting the phase of the aerosol generating material inside the cartridge to a gaseous phase. The term “aerosol” may refer to a gas in which vaporized particles generated from the aerosol generating material are mixed with air.

In another embodiment, the aerosol generating device may generate an aerosol by heating the liquid composition, and the generated aerosol may pass through the aerosol generating article and be delivered to the user. That is, the aerosol generated from the liquid composition may travel along airflow paths of the aerosol generating device, and the airflow paths may be configured to allow the aerosol to pass through the aerosol generating article and be delivered to the user.

In another embodiment, the aerosol generating device may be a device that generates an aerosol from the aerosol generating material using an ultrasonic vibration manner. In this case, the ultrasonic vibration manner may refer to a manner of generating an aerosol by atomizing the aerosol generating material with ultrasonic vibration generated by a vibrator.

The aerosol generating device may include a vibrator, and may generate vibration at short intervals through the vibrator to atomize the aerosol generating material. The vibration generated by the vibrator may be ultrasonic vibration, and a frequency band of the ultrasonic vibration may be from about 100 kilohertz (kHz) to about 3.5 megahertz (MHz). However, embodiments are not limited thereto.

The aerosol generating device may further include a wick that absorbs the aerosol generating material. For example, the wick may be disposed to surround at least one area of the vibrator or may be disposed to contact at least one area of the vibrator.

As a voltage (e.g., an alternating voltage) is applied to the vibrator, the vibrator may generate heat and/or ultrasonic vibration, and the heat and/or ultrasonic vibration generated by the vibrator may be transmitted to the aerosol generating material absorbed in the wick. The aerosol generating material absorbed in the wick may be converted into a gas phase by the heat and/or ultrasonic vibration transmitted from the vibrator, and consequently, an aerosol may be generated.

For example, the viscosity of the aerosol generating material absorbed in the wick may be lowered by the heat generated by the vibrator, and the aerosol generating material with lowered viscosity may be changed to fine particles by the ultrasonic vibration generated by the vibrator, and thereby an aerosol may be generated. However, embodiments are not limited thereto.

In another embodiment, the aerosol generating device may be a device that generates an aerosol by heating the aerosol generating article accommodated therein in an induction heating manner.

The aerosol generating device may include a susceptor and a coil. In an embodiment, the coil may apply a magnetic field to the susceptor. As the aerosol generating device supplies power to the coil, a magnetic field may be formed inside the coil. In an embodiment, the susceptor may be a magnetic body that generates heat by an external magnetic field. As the susceptor is positioned inside the coil and generates heat with the magnetic field applied, the aerosol generating article may be heated. Also, optionally, the susceptor may be positioned in the aerosol generating article.

In another embodiment, the aerosol generating device may further include a cradle.

The aerosol generating device and the separate cradle may form a system together. For example, the cradle may be used to charge a battery of the aerosol generating device. Alternatively, a heater may be heated when the cradle and the aerosol generating device are coupled to each other.

Hereinafter, embodiments of the disclosure will be described in detail with reference to the accompanying drawings such that one of ordinary skill in the art may easily practice the disclosure. The disclosure may be practiced in forms that are implementable in the aerosol generating devices according to various embodiments described above or may be embodied and practiced in many different forms and is not limited to the embodiments described herein.

Hereinafter, embodiments of the disclosure will be described in detail with reference to the drawings.

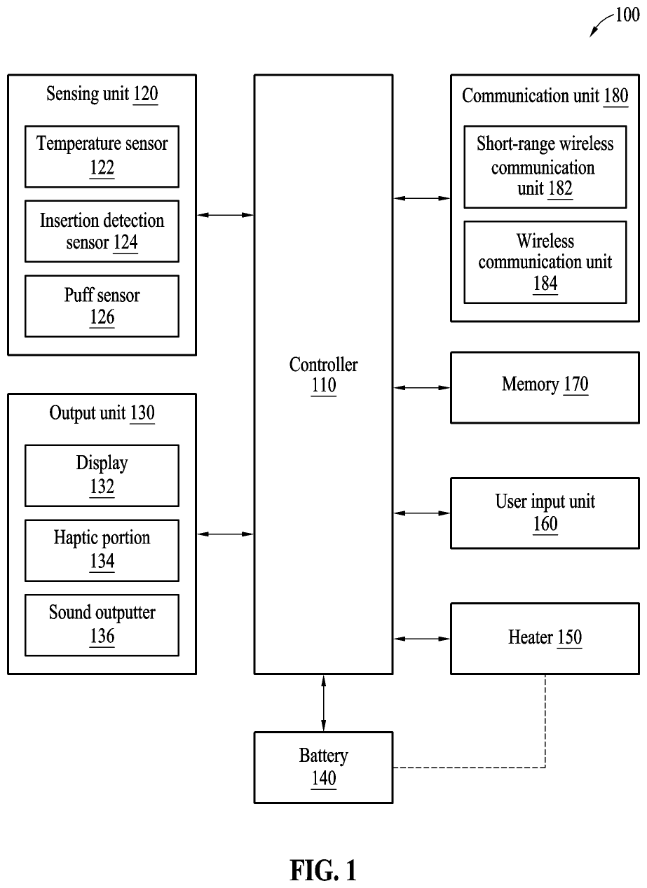

FIG. 1 is a block diagram of an aerosol generating device 100 according to an embodiment.

The aerosol generating device 100 may include a controller 110, a sensing unit 120, an output unit 130, a battery 140, a heater 150, a user input unit 160, a memory 170, and a communication unit 180. However, an internal structure of the aerosol generating device 100 is not limited to what is shown in FIG. 1. It is to be understood by one of ordinary skill in the art to which the disclosure pertains that some of the components shown in FIG. 1 may be omitted or new components may be added according to the design of the aerosol generating device 100.

The sensing unit 120 may sense a state of the aerosol generating device 100 or a state of an environment around the aerosol generating device 100, and transmit sensing information obtained through the sensing to the controller 110. Based on the sensing information, the controller 110 may control the aerosol generating device 100 to control operations of the heater 150, restrict smoking, determine whether an aerosol generating article (e.g., an aerosol generating article, a cartridge, etc.) is inserted, display a notification, and perform other functions.

The sensing unit 120 may include at least one of a temperature sensor 122, an insertion detection sensor 124, or a puff sensor 126. However, embodiments are not limited thereto.

The temperature sensor 122 may sense a temperature at which the heater 150 (or an aerosol generating material) is heated. The aerosol generating device 100 may include a separate temperature sensor for sensing the temperature of the heater 150, or the heater 150 itself may function as a temperature sensor. Alternatively, the temperature sensor 122 may be arranged around the battery 140 to monitor the temperature of the battery 140.

The insertion detection sensor 124 may sense whether the aerosol generating article is inserted and/or removed. The insertion detection sensor 124 may include, for example, at least one of a film sensor, a pressure sensor, a light sensor, a resistive sensor, a capacitive sensor, an inductive sensor, or an infrared sensor, which may sense a signal change by the insertion and/or removal of the aerosol generating article.

The puff sensor 126 may sense a puff from a user based on various physical changes in an airflow path or airflow channel. For example, the puff sensor 126 may sense the puff from the user based on any one of a temperature change, a flow change, a voltage change, and a pressure change.

The sensing unit 120 may further include at least one of a temperature/humidity sensor, an atmospheric pressure sensor, a magnetic sensor, an acceleration sensor, a gyroscope sensor, a position sensor (e.g., a global positioning system (GPS)), a proximity sensor, or a red, green, blue (RGB) sensor (e.g., an illuminance sensor), in addition to the sensors 122 through 126 described above. A function of a sensor may be intuitively inferred from the name of the sensor by one of ordinary skill in the art, and thus, a more detailed description thereof is not included here.

The output unit 130 may output information about the state of the aerosol generating device 100 and provide the information to the user. The output unit 130 may include at least one of a display 132, a haptic portion 134, or a sound outputter 136. However, embodiments are not limited thereto. When the display 132 and a touchpad are provided in a layered structure to form a touchscreen, the display 132 may be used as an input device in addition to an output device.

The display 132 may visually provide information about the aerosol generating device 100 to the user. The information about the aerosol generating device 100 may include, for example, a charging/discharging state of the battery 140 of the aerosol generating device 100, a preheating state of the heater 150, an insertion/removal state of the aerosol generating article, a limited usage state (e.g., an abnormal article detected) of the aerosol generating device 100, or the like, and the display 132 may externally output the information. The display 132 may be, for example, a liquid-crystal display panel (LCD), an organic light-emitting display panel (OLED), or the like. The display 132 may also be in the form of a light-emitting diode (LED) device.

The haptic portion 134 may provide information about the aerosol generating device 100 to the user in a haptic way by converting an electrical signal into a mechanical stimulus or an electrical stimulus. The haptic portion 134 may include, for example, a motor, a piezoelectric element, or an electrical stimulation device.

The sound outputter 136 may provide information about the aerosol generating device 100 to the user in an auditory way. For example, the sound outputter 136 may convert an electric signal into a sound signal and externally output the sound signal.

The battery 140 may supply power to be used to operate the aerosol generating device 100. The battery 140 may supply power to heat the heater 150. In addition, the battery 140 may supply power required for operations of the other components (e.g., the sensing unit 120, the output unit 130, the user input unit 160, the memory 170, and the communication unit 180) included in the aerosol generating device 100. The battery 140 may be a rechargeable battery or a disposable battery. The battery 140 may be, for example, a lithium polymer (LiPoly) battery. However, embodiments are not limited thereto.

The heater 150 may receive power from the battery 140 to heat the aerosol generating material. Although not shown in FIG. 1, the aerosol generating device 100 may further include a power conversion circuit (e.g., a direct current (DC)-to-DC (DC/DC) converter) that converts power of the battery 140 and supplies the power to the heater 150. In addition, when the aerosol generating device 100 generates an aerosol in an induction heating manner, the aerosol generating device 100 may further include a DC-to-alternating current (AC) (DC/AC) converter that converts DC power of the battery 140 into AC power.

The controller 110, the sensing unit 120, the output unit 130, the user input unit 160, the memory 170, and the communication unit 180 may receive power from the battery 140 to perform functions. Although not shown in FIG. 1, the aerosol generating device 100 may further include a power conversion circuit, for example, a low dropout (LDO) circuit or a voltage regulator circuit, which converts power of the battery 140 and supplies the power to respective components.

In an embodiment, the heater 150 may be formed of a predetermined electrically resistive material that is suitable. The electrically resistive material may be a metal or a metal alloy including, for example, titanium, zirconium, tantalum, platinum, nickel, cobalt, chromium, hafnium, niobium, molybdenum, tungsten, tin, gallium, manganese, iron, copper, stainless steel, nichrome, or the like. However, embodiments are not limited thereto. In addition, the heater 150 may be implemented as a metal heating wire, a metal heating plate on which an electrically conductive track is arranged, a ceramic heating element, or the like, but is not limited thereto.

In another embodiment, the heater 150 may be an induction heater. For example, the heater 150 may include a susceptor that heats the aerosol generating material by generating heat through a magnetic field applied by a coil.

In an embodiment, the heater 150 may include a plurality of heaters. For example, the heater 150 may include a first heater for heating the aerosol generating article and a second heater for heating a liquid.

The user input unit 160 may receive information input from the user or may output information to the user. For example, the user input unit 160 may include a keypad, a dome switch, a touchpad (e.g., a contact capacitive type, a pressure resistive film type, an infrared sensing type, a surface ultrasonic conduction type, an integral tension measurement type, a piezo effect method, etc.), a jog wheel, a jog switch, or the like. However, embodiments are not limited thereto. In addition, although not shown in FIG. 1, the aerosol generating device 100 may further include a connection interface such as a universal serial bus (USB) interface, and may be connected to another external device through the connection interface such as a USB interface to transmit and receive information or to charge the battery 140.

The memory 170, which is hardware for storing various pieces of data processed in the aerosol generating device 100, may store data processed by the controller 110 and data to be processed thereby. The memory 170 may include at least one type of storage medium of a flash memory type memory, a hard disk type memory, a multimedia card micro type memory, a card type memory (e.g., an SD or XE memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk. The memory 170 may store an operating time of the aerosol generating device 100, a maximum number of puffs, a current number of puffs, at least one temperature profile, data associated with a smoking pattern of the user, or the like.

The communication unit 180 may include at least one component for communicating with another electronic device. For example, the communication unit 180 may include a short-range wireless communication unit 182 and a wireless communication unit 184.

The short-range wireless communication unit 182 may include a Bluetooth communication unit, a BLE communication unit, a near field communication unit, a WLAN (Wi-Fi) communication unit, a ZigBee communication unit, an infrared data association (IrDA) communication unit, a Wi-Fi direct (WFD) communication unit, an ultra-wideband (UWB) communication unit, and an Ant+communication unit. However, embodiments are not limited thereto.

The wireless communication unit 184 may include, for example, a cellular network communicator, an Internet communicator, a computer network (e.g., a local area network (LAN) or a wide-area network (WAN)) communicator, or the like. However, embodiments are not limited thereto. The wireless communication unit 184 may use subscriber information (e.g., international mobile subscriber identity (IMSI)) to identify and authenticate the aerosol generating device 100 in a communication network.

The controller 110 may control the overall operation of the aerosol generating device 100. In an embodiment, the controller 110 may include at least one processor. The processor may be implemented as an array of a plurality of logic gates, or may be implemented as a combination of a general-purpose microprocessor and a memory in which a program executable by the microprocessor is stored. In addition, it is to be understood by one of ordinary skill in the art to which the disclosure pertains that the processor may be implemented in other types of hardware.

The controller 110 may control the temperature of the heater 150 by controlling the supply of power from the battery 140 to the heater 150. For example, the controller 110 may control the supply of power by controlling switching of a switching element between the battery 140 and the heater 150. In another example, a direct heating circuit may control the supply of power to the heater 150 according to a control command from the controller 110.

The controller 110 may analyze a sensing result obtained by the sensing of the sensing unit 120 and control processes to be performed thereafter. For example, the controller 110 may control power to be supplied to the heater 150 to start or end an operation of the heater 150 based on the sensing result obtained by the sensing unit 120. As another example, the controller 110 may control an amount of power to be supplied to the heater 150 and a time for which the power is to be supplied, such that the heater 150 may be heated up to a predetermined temperature or maintained at a desired temperature, based on the sensing result obtained by the sensing unit 120.

The controller 110 may control the output unit 130 based on the sensing result obtained by the sensing unit 120. For example, when the number of puffs counted through the puff sensor 126 reaches a preset number, the controller 110 may inform the user that operation of the aerosol generating device 100 is ending soon, through at least one of the display 132, the haptic portion 134, or the sound outputter 136.

In an embodiment, the controller 110 may control a power supply time and/or a power supply amount for the heater 150 according to a state of the aerosol generating article sensed by the sensing unit 120. For example, when the aerosol generating article is in an over-humidified state, the controller 110 may control the power supply time for an inductive coil to increase a preheating time, compared to a case where the aerosol generating article is in a general state.

An embodiment may also be implemented in the form of a recording medium including instructions executable by a computer, such as a program module executable by the computer. A computer-readable medium may be any available medium that can be accessed by a computer and includes a volatile medium, a non-volatile medium, a removable medium, and a non-removable medium. In addition, the computer-readable medium may include both a computer storage medium and a communication medium. The computer storage medium includes all of a volatile medium, a non-volatile medium, a removable medium, and a non-removable medium implemented by any method or technology for storage of information such as computer-readable instructions, data structures, program modules or other data. The communication medium typically includes computer-readable instructions, data structures, other data in modulated data signals such as program modules, or other transmission mechanisms, and includes any information transfer medium.

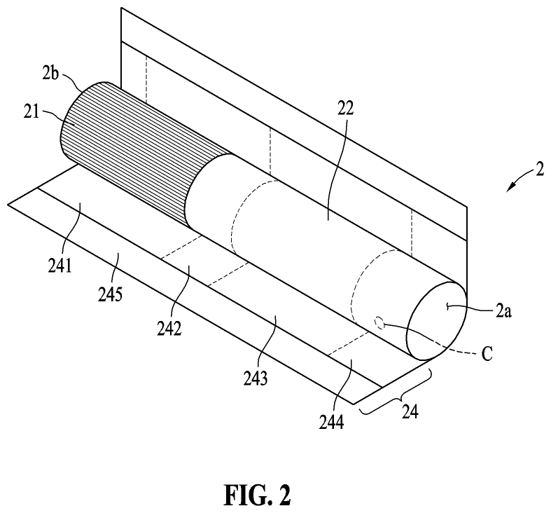

FIG. 2 is a schematic diagram of an aerosol generating article 2 according to an embodiment.

Referring to FIG. 2, the aerosol generating article 2 may include a first end 2a, a second end 2b formed on an opposite side of the first end 2A. That is, a length of the aerosol generating article 2 may be defined as a distance between the first end 2a and the second end 2b. According to an embodiment, the aerosol generating article 2 may include a first segment 21 and a second segment 22, which are arranged along a lengthwise direction (i.e., longitudinal direction).

The second segment 22 is illustrated as having a single unit in FIG. 2. However, embodiments are not limited thereto. In other words, the second segment 22 may include a plurality of units. For example, the second segment 22 may include a unit that cools an aerosol and a unit that filters a predetermined ingredient contained in the aerosol. In addition, the second segment 22 may further include more units that perform other functions.

The aerosol generating article 2 may be wrapped with at least one wrapper 24. The wrapper 24 may have at least one hole through which external air is introduced or internal gas flows out. As an example, the aerosol generating article 2 may be wrapped with one wrapper 24. As another example, the aerosol generating article 2 may be wrapped with two or more of wrappers 24 in an overlapping manner. For example, the first segment 21 may be wrapped with a first wrapper 241, and the second segment 22 may be wrapped with wrappers 242, 243, and 244. In addition, the aerosol generating article 2 may be entirely wrapped again with a single fifth wrapper 245. If the second segment 22 includes a plurality of segments, the segments may be wrapped with the wrappers 242, 243, and 244, respectively.

The first wrapper 241 and the second wrapper 242 may be formed of general filter wrapping paper. For example, the first wrapper 241 and the second wrapper 242 may be porous wrapping paper or non-porous wrapping paper. In addition, the first wrapper 241 and the second wrapper 242 may be formed of oilproof paper and/or an aluminum laminated wrapping material.

The third wrapper 243 may be formed of hard wrapping paper. For example, a basis weight of the third wrapper 243 may be in a range of 88 grams per square meter (g/m²) to 96 g/m², and desirably, may be in a range of 90 g/m² to 94 g/m². In addition, a thickness of the third wrapper 243 may be in a range of 120 micrometer (μm) to 130 μm, and desirably, may be 125 μm.

The fourth wrapper 244 may be formed of oilproof hard wrapping paper. For example, a basis weight of the fourth wrapper 244 may be in a range of 88 g/m² to 96 g/m², and desirably, may be in a range of 90 g/m² to 94 g/m². In addition, a thickness of the fourth wrapper 244 may be in a range of 120 μm to 130 μm, and desirably, may be 125 μm.

The fifth wrapper 245 may be formed of sterile paper (e.g., MFW). Here, the term “sterile paper (e.g., MFW)” may refer to paper specially prepared such that it has enhanced tensile strength, water resistance, smoothness, or the like, compared to general paper. For example, a basis weight of the fifth wrapper 245 may be in a range of 57 g/m² to 63 g/m², and desirably, may be 60 g/m². In addition, a thickness of the fifth wrapper 245 may be in a range of 64 μm to 70 μm, and desirably, may be 67 μm.

The fifth wrapper 245 may include a predetermined material. The material may be, for example, silicon. However, embodiments are not limited thereto. Silicon may have properties, such as, for example, heat resistance which is characterized by less change by temperature, oxidation resistance which refers to resistance to oxidation, resistance to various chemicals, repellency against water, or electrical insulation. However, silicon may not necessarily be used, and any material having properties such as those described above may be applied to (e.g., used to coat) the fifth wrapper 245 without limitation.

In addition, the fifth wrapper 245 may prevent a holder (e.g., aerosol generating device) from being contaminated by substances produced in the aerosol generating article 2. Liquid substances may be produced in the aerosol generating article 2 when a user puffs. For example, as an aerosol generated in the aerosol generating article 2 is cooled by external air, such liquid substances (e.g., moisture, etc.) may be produced. As the aerosol generating article 2 is wrapped with the fifth wrapper 245, the liquid substances generated within the aerosol generating article 2 may be prevented from leaking out of the aerosol generating article 2.

The first segment 21 may include an aerosol generating material. The aerosol generating material may include, for example, at least one of glycerin, propylene glycol, ethylene glycol, dipropylene glycol, diethylene glycol, triethylene glycol, tetraethylene glycol, and oleyl alcohol. However, embodiments are not limited thereto. The first segment 21 may also include other additives such as a flavoring agent, a wetting agent, and/or organic acid. In addition, the first segment 21 may include a flavoring liquid such as menthol or a moisturizing agent that is added as being sprayed onto the first segment 21.

The first segment 21 may be manufactured in various ways. For example, the first segment 21 may be formed as a sheet or a strand. The first segment 21 may also be formed of tobacco leaves finely cut from a tobacco sheet. In addition, the first segment 21 may be enveloped by a thermally conductive material. The thermally conductive material may be, for example, a metal foil such as an aluminum foil. However, embodiments are not limited thereto. For example, the thermally conductive material enveloping the first segment 21 may evenly distribute heat to the first segment 21, thereby improving taste of tobacco.

The second segment 22 may be a cellulose acetate filter. However, a shape of the second segment 22 is not limited. For example, the second segment 22 may be a cylindrical rod, or a tubular rod including a hollow therein. The second segment 22 may also be a recess-type rod. For example, when the second segment 22 includes a plurality of sections, at least one of the sections may be manufactured in a different shape.

A first section of the second segment 22 may be a cellulose acetate filter. For example, the first section may be a tubular structure including a hollow therein.

The first section may have a hardness, which may be adjusted by adjusting content of a plasticizer in a process of manufacturing the first section. In addition, the first section may be manufactured by inserting a structure such as a film or a tube of the same or different materials therein (e.g., in the hollow).

A second section of the second segment 22 may cool an aerosol generated as a heater 150 heats the first segment 21. The user may thus inhale the aerosol cooled down to a suitable temperature.

A length or diameter of the second section may be determined in various ways according to the shape of the aerosol generating article 2. For example, a desirable length of the second section may be adopted from a range of 7 millimeters (mm) to 20 mm. Desirably, the length of the second segment may be about 14 mm. However, embodiments are not limited thereto.

The second section may be manufactured by weaving a polymer fiber. In this case, a flavoring liquid may be applied to a fiber formed of a polymer. Alternatively, the second section may be manufactured by weaving a separate fiber to which a flavoring liquid is applied and the fiber formed of the polymer together. Alternatively, the second section may be formed of a crimped polymer sheet.

For example, the polymer may be prepared with a material selected from the group consisting of polyethylene (PE), polypropylene (PP), polyvinyl chloride (PVC), polyethylene terephthalate (PET), polylactic acid (PLA), cellulose acetate (CA,) and an aluminum foil.

As the second section is formed of the woven polymer fiber or the crimped polymer sheet, the second section may include a single channel or a plurality of channels extending in a longitudinal direction. The term channel used herein may refer to a path through which a gas (e.g., air or aerosol) passes.

For example, the second section formed of the crimped polymer sheet may be formed such that the crimped polymer sheet has a thickness between about 5 μm and about 300 μm, for example, between about 10 μm and about 250 μm. In addition, a total surface area of the second section may be between about 300 mm²/mm and about 1000 mm²/mm. Further, an aerosol cooling element may be formed of a material having a specific surface area of between about 10 mm²/mg and about 100 mm²/mg.

The second section may include a thread containing a volatile flavor ingredient. The volatile flavor ingredient may be menthol. However, embodiments are not limited thereto. For example, the thread may be filled with an amount of menthol sufficient to provide at least 1.5 milligrams (mg) of menthol to the second section.

A third section of the second segment 22 may be a cellulose acetate filter. A desirable length of the third section may be adopted from a range of 4 mm to 20 mm.

In addition, the second segment 22 may include at least one capsule C. The capsule C may perform a function of generating a flavor or a function of generating an aerosol. For example, the capsule C may have a structure in which a liquid containing a fragrance is wrapped with a film. The capsule C may have a spherical or cylindrical shape. However, embodiments are not limited thereto.

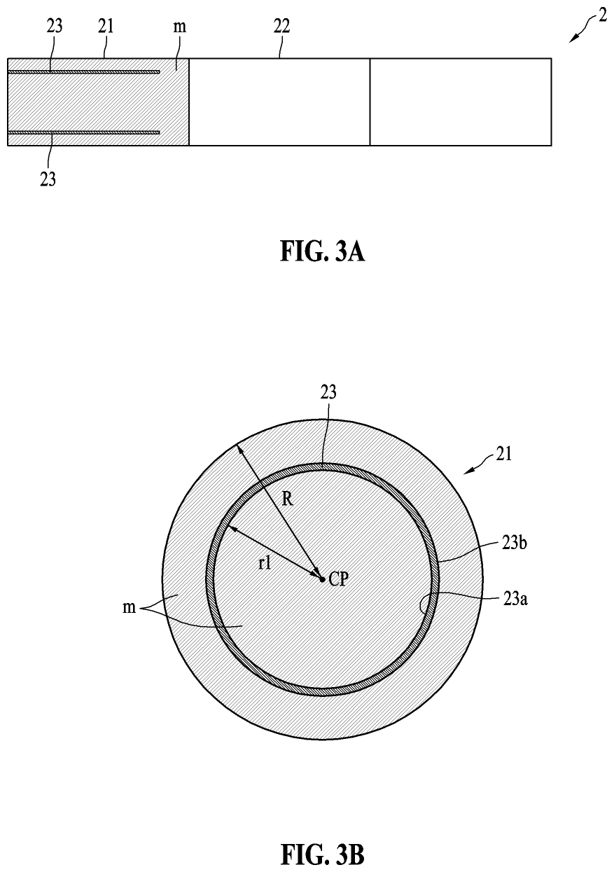

FIGS. 3A and 3B are diagrams schematically illustrating an aerosol generating article according to an embodiment.

According to an embodiment, the first segment 21 of the aerosol generating article 2 may include a filling material m and a susceptor 23 (e.g., a susceptor included in the heater 150 of FIG. 1). In an embodiment, the filling material m may include a medium (e.g., nicotine) that is transferred to a mouth of a user. The susceptor 23 may be any material capable of converting electromagnetic energy into heat. Positioned in a fluctuating magnetic field, the susceptor 23 may be heated by an eddy current induced in the susceptor 23. According to an embodiment, the susceptor 23 may be in a thermal contact with the filling material m, and the filling material m may be heated by the susceptor 23.

According to an embodiment, since the susceptor 23 is used to heat the filling material m, heating efficiency may increase as a contact area between the susceptor 23 and the filling material m increases. The susceptor 23 may be configured to enclose at least a portion of the filling material m and to be enclosed by another portion of the filling material m. In other words, the susceptor 23 may include a first surface 23a and a second surface 23b opposite to the first surface 23a. The first surface 23a may be disposed to face a center CP of the first segment 21, and the second surface 23b may be disposed to face the surface of the first segment 21. According to an embodiment, the susceptor 23 may have a cylindrical shape including an inner surface (e.g., the first surface 23a) and an outer surface (e.g., the second surface 23b). According to an embodiment, the cylindrical susceptor 23 may extend in a longitudinal direction in the first segment 21. When the susceptor is heated by the eddy current induced in the susceptor by a coil of an aerosol generating device, the filling material m touching the first surface 23a and the second surface 23b may be heated by double-sided heating. Double-sided heating through the first surface 23a and the second surface 23b of the susceptor 23 may heat a larger surface area of the filling material m compared to single-sided heating, thereby improving heating efficiency.

According to an embodiment, the susceptor 23 may be formed of a material having high thermal conductivity to efficiently provide heat to the filling material m. For example, the susceptor 23 may include at least one of aluminum, gold, iron, nickel, cobalt, conductive carbon, graphite, mild steel, stainless steel, copper, and bronze.

Referring to FIG. 3B, according to an embodiment, the susceptor 23 may be the cylindrical susceptor 23 having a predetermined radius r1. According to an embodiment, the radius r1 of the cylindrical susceptor 23 may be greater than or equal to a half of the radius R of the first segment 21, and less than the radius R of the first segment 21. According to an embodiment, the radius R of the first segment 21 may be 2 mm to 7 mm.

When the cylindrical susceptor 23 encloses an outside of the filling material m of the first segment 21 (e.g., when the radius r1 of the cylindrical susceptor 23 is equal to the radius R of the first segment 21), a surface area of the filling material m heated in contact with the susceptor 23 may be calculated by the Equation below.

$$S a = 2 * π * R * h$$

Sa may denote the surface area (m²) of the filling material m heated in contact with the susceptor 23 that encloses the outside of the filling material m, n may denote a ratio of a circumference to a diameter, R may denote a radius (mm) of the first segment 21, and h may denote a length of the cylindrical susceptor 23.

On the other hand, when the radius r1 of the cylindrical susceptor 23 is less than the radius R of the first segment 21, the surface area of the filling material m heated in contact with the susceptor 23 may be calculated by the Equation below.

$$S b = 4 * π * r 1 * h$$

Sb may denote the surface area (m²) of the filling material m heated in contact with the susceptor 23 that encloses the inside or outside of the filling material, x may denote the ratio of the circumference to the diameter, r1 may denote the radius (mm) of the cylindrical susceptor 23, and h may denote the length of the cylindrical susceptor 23. According to an embodiment, when the radius r1 of the cylindrical susceptor 23 is less than the radius R of the first segment 21, the cylindrical susceptor 23 may allow not only the first surface 23a but also the second surface 23b to contact the filling material m and heat the filling material m. Thus, heating efficiency may be two times higher than when the cylindrical susceptor 23 having the same radius r1 encloses the outside of the filling material m of the first segment 21. To achieve heating efficiency that is equal to or higher than the heating efficiency in a case where the cylindrical susceptor 23 encloses the outside of the filling material m of the first segment 21, Sb may need to be equal to or greater than Sa. Therefore, the condition expressed by the Equation below may need to be met.

$$2 * π * R * h \leq 4 * π * r 1 * h$$

As a consequence, the radius r1 of the cylindrical susceptor 23 may need to be less than the radius R of the first segment 21. Therefore, the condition expressed by the Equation below may need to be met.

$$R / 2 \leq r 1 \leq R$$

That is, according to an embodiment, the radius r1 of the cylindrical susceptor 23 may be greater than or equal to the half of the radius R of the first segment 21 and be less than the radius R of the first segment 21.

Table 1 below shows a cross sectional area according to the radius r1 of the susceptor 23 when the cylindrical susceptor 23 encloses the outside of the filling material m of the first segment 21 (external heating) and when the radius r1 of the cylindrical susceptor 23 is less than the radius R of the first segment 21 (internal and external heating).

TABLE 1

| External heating | | | | Internal and external heating | | | |
|---|---|---|---|---|---|---|---|
| | | | Cross- | | | | Cross- |
| Ra- | Circum- | Medium | section- | Ra- | Circum- | Medium | section- |
| dius | ference | length | al area | dius | ference | length | al area |
| R | (mm) | h | Sa | r1 | (mm) | h | Sb |
| 3.61 | 22.65 | 12.00 | 43.3 | 3.61 | 22.65 | 12.00 | 43.3 |
| — | — | — | — | 1.805 | 11.33 | 12.00 | 43.3 |
| — | — | — | — | 3.60 | 22.60 | 12.00 | 86.4 |

As shown in Table 1, a cross-sectional area of the filling material m that is heated when the radius r1 of the cylindrical susceptor 23 is less than the radius R of the first segment 21 (i.e., when heated by internal and external heating) may be two times larger than a cross-sectional area of the filling material m that is only heated with external heating of the susceptor 23 having the same radius R.

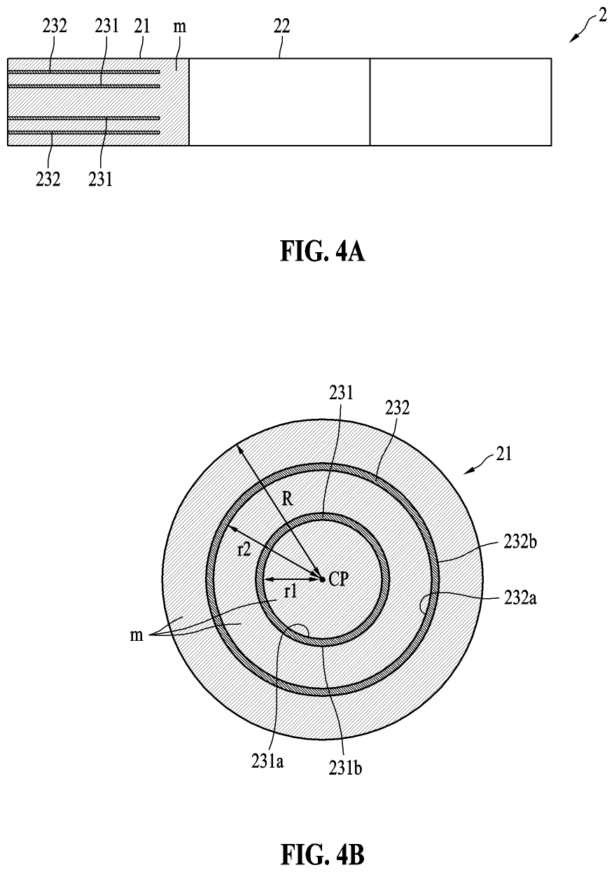

FIGS. 4A and 4B are diagrams schematically illustrating the aerosol generating article 2 including a plurality of susceptors 23 according to an embodiment.

According to an embodiment, the aerosol generating article 2 may include the first segment 21, the second segment 22, and the susceptor 23. According to an embodiment, the susceptor 23 may include a first susceptor 231 and a second susceptor 232. The first susceptor 231 and the second susceptor 232 may be cylindrical susceptors having a first radius r1 and a second radius r2, respectively.

Referring to FIG. 4B, the first susceptor 231 may include a first surface 231a facing the center CP of the first segment 21 and a second surface 231b disposed to face the surface of the first segment 21 opposite to the first surface 231a. In an embodiment, the second susceptor 232 may include a first surface 232a facing the center CP of the first segment 21 and a second surface 232b disposed to face the outer surface of the first segment 21 opposite to the first surface 232a. In an embodiment, the second radius r2 of the second susceptor 232 may be greater than the first radius r1 of the first susceptor 231, and a cross-section of a cylinder formed by each of the first susceptor 231 and the second susceptor 232 may be a concentric circle sharing the same center CP. That is, the second surface 231b of the first susceptor 231 and the first surface 232a of the second susceptor 232 may be disposed to face each other. In an embodiment, both the first radius r1 of the first susceptor 231 and the second radius r2 of the second susceptor 232 may be greater than or equal to a half of the radius R of the first segment 21. In another embodiment, the first radius r1 of the first susceptor 231 may be less than or equal to the radius R of the first segment 21, and the second radius r2 of the second susceptor 232 may be greater than or equal to a half of the radius R of the first segment 21.

In an embodiment where the radius r1 of the first susceptor 231 and the radius r2 of the second susceptor 232 are less than the radius R of the first segment 21, a surface area of the filling material m heated in contact with the first susceptor 231 and the second susceptor 232 may be calculated by the Equation below.

$$S c = 4 * π * ( r 1 + r 2 ) * h$$

Sc may denote a surface area (m²) of the filling material m heated in contact with the susceptors 231 and 232 that enclose inside and outside of the filling material, π may denote a ratio of a circumference to a diameter, r1 may denote a radius (mm) of the first susceptor 231, r2 may denote a radius (mm) of the second susceptor 232, and h may denote lengths of the susceptors 231 and 232. In an embodiment, the lengths of the first susceptor 231 and the second susceptor 232 may be identical to each other. In another embodiment, the lengths of the first susceptor 231 and the second susceptor 232 may be different from each other.

In an embodiment, the susceptor 23 may further include a third susceptor. The third susceptor may be a cylindrical susceptor having a third radius, and the third radius may be greater than the second radius r2 of the second susceptor 232. In an embodiment of the aerosol generating article 2 having the plurality of susceptors 23, the susceptor 23 is not limited to a specific number and may include more susceptors 23.

Hereinafter, the filling material m according to an embodiment is described in detail.

The filling material m filled in the first segment 21 may include a medium that is transferred to a mouth of a user. According to an embodiment, the medium may include solid materials based on tobacco raw materials such as tobacco sheets, cut tobacco leaves, and reconstituted tobacco and a liquid composition based on nicotine, a tobacco extract, and/or various fragrances. However, the medium is not limited thereto and may include materials such as vitamin, taurine, caffeine, and GABA.

According to an embodiment, the filling material m may further include a thermally conductive powdered material in addition to the above-mentioned medium. The thermally conductive powdered material may be a material that is in a powdered form, including at least one of aluminum, gold, iron, nickel, cobalt, conductive carbon, graphite, mild steel, stainless steel, copper, and bronze. When the medium and the thermally conductive powdered material are mixed and filled in the first segment 21, heating efficiency in heating the filling material m increases. Thus, the medium may be heated at a much faster speed and battery efficiency of an aerosol generating device may also be improved.

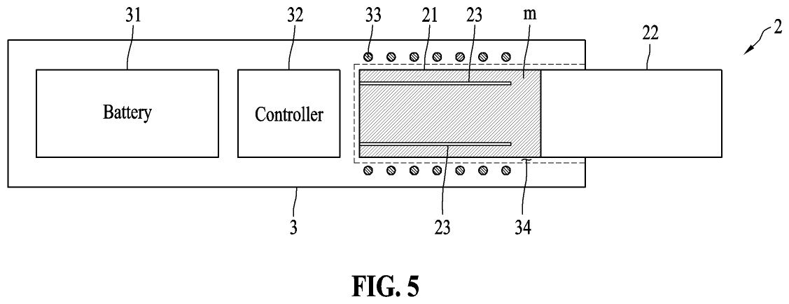

FIG. 5 is a diagram schematically illustrating an aerosol generating system according to an embodiment.

Referring to FIG. 5, according to an embodiment, the aerosol generating system may include the aerosol generating article 2 and an aerosol generating device 3.

According to an embodiment, the aerosol generating article 2 may include the first end 2a (e.g., the first end 2a of FIG. 2), the second end 2b (e.g., the second end 2b of FIG. 2) opposite to the first end 2a. That is, a length of the aerosol generating article 2 may be define as a distance from the first end 2a to the second end 2b, and the first segment 21 and the second segment 22 are aligned along a lengthwise direction. According to an embodiment, the first segment 21 may include the filling material m and the susceptor 23 that encloses at least a portion of the filling material m.

According to an embodiment, the aerosol generating device may include a battery 31 (e.g., the battery 140 of FIG. 1), a controller 32 (e.g., the controller 110 of FIG. 1), a coil 33, and an article insertion portion 34 that accommodates the aerosol generating article 2.

The battery 31 (e.g., the battery 140 of FIG. 1) may supply power to be used to operate the aerosol generating device 3. For example, the battery 31 may supply power to the coil 33 such that the susceptor 23 in the aerosol generating article 2 is heated and may supply power required for the controller 32 (e.g., the controller 110 of FIG. 1) to operate. In addition, the battery 31 may supply power required to operate a display, a sensor, a motor, or the like installed in the aerosol generating device 3.

The controller 32 (e.g., the controller 110 of FIG. 1) may control an overall operation of the aerosol generating device 3. For example, the controller 32 may control power supplied to the coil 33 from the battery 31. The controller 32 may also control respective operations of other components included in the aerosol generating device 3, in addition to the battery 31 and the coil 33. In addition, the controller 32 may verify a state of each of the components of the aerosol generating device 3 to determine whether the aerosol generating device 3 is in an operable state.

The controller 32 may include at least one processor. The processor may be implemented as an array of a plurality of logic gates, or may be implemented as a combination of a general-purpose microprocessor and a memory in which a program executable by the microprocessor is stored. In addition, it is to be understood by one of ordinary skill in the art to which the disclosure pertains that the processor may be implemented in other types of hardware.

When the aerosol generating article 2 is accommodated in the article insertion portion 34 of the aerosol generating device 3, the aerosol generating device 3 may heat the aerosol generating article with an induction heating manner. The heated susceptor 23 increases a temperature of the filling material m in the aerosol generating article 2, and thus, an aerosol may be generated. The generated aerosol may be transmitted to a mouth of a user in the direction of the length of the aerosol generating article 2.

The coil 33 of the aerosol generating device 3 may be wound along a side surface of a space in which the aerosol generating article 2 is accommodated and generate an induced magnetic field, and the susceptor 23 may be disposed at a position corresponding to a position of the coil 33 and generate heat by the induced magnetic field generated by the coil 33.

An induction heating manner may be a manner of generating heat from a magnetic field by applying an alternating magnetic field of which a direction changes periodically to the magnetic body that generates heat by an external magnetic field. The magnetic field that generates heat by the external magnetic field may be the susceptor 23 according to an embodiment.

When the alternating magnetic field is applied to the magnetic body, an energy loss due to an eddy current loss and a hysteresis loss may occur in the magnetic body, and lost energy may be emitted from the susceptor 23 as thermal energy. As an amplitude or a frequency of the alternating magnetic field applied to the susceptor 23 increases, an amount of thermal energy emitted from the susceptor 23 may increase. The aerosol generating device 3 may enable the magnetic body to emit thermal energy by applying the alternating magnetic field to the susceptor 23 and transmit thermal energy emitted from the susceptor 23 to the filling material m.

Hereinafter, a method of manufacturing the aerosol generating article 2 is described in detail according to an embodiment.

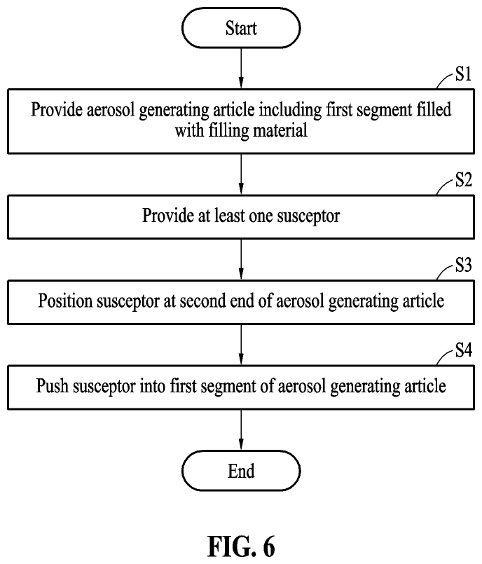

FIG. 6 is a flow chart of a method of manufacturing the aerosol generating article 2 according to an embodiment.

Referring to FIG. 6, according to an embodiment, the method of manufacturing the aerosol generating article 2 may include operation S1 of providing the aerosol generating article 2, operation S2 of providing the susceptor 23, operation S3 of positioning the susceptor 23 at a longitudinal end of the aerosol generating article 2, and operation S4 of pushing the susceptor 23 into the first segment 21 of the aerosol generating article 2.

In detail, operation S1 of providing the aerosol generating article 2 may be an operation of providing the aerosol generating article 2 including the first segment 21 filled with the filling material m. According to an embodiment, operation S1 of providing the aerosol generating article 2 may include manufacturing the aerosol generating article 2.

As described above, operation S2 of providing the susceptor 23 may be an operation of providing the susceptor 23 that is to be pushed into the first segment 21 of the aerosol generating article 2.

In operation S3, the susceptor 23 may be positioned at a second end (e.g., the second end 2b of FIG. 2) of the aerosol generating article 2. In an embodiment, the operation of positioning the susceptor 23 at the second end may include an operation of positioning the susceptor 23 at a center of the aerosol generating article 2. Desirably, the susceptor 23 may be symmetrically positioned with respect to the center CP of the filling material m. In order to achieve an even or symmetrical heat distribution of the filling material m in the aerosol generating article 2 or the first segment 21, positioning the susceptor 23 at the center CP may be advantageous.

In operation S4, the susceptor 23 may be pushed into the first segment 21 through the second end of the aerosol generating article 2. Operation S4 of pushing the susceptor 23 into the first segment 21 of the aerosol generating article 2 may be performed automatically or manually. Electronic control corresponding to an insertion process, or possibly electronic control corresponding to one or more of feed mechanisms, may be provided.

In a fully automated process, continuous manufacture of the aerosol generating article 2 may be achieved according to an embodiment. Such continuous manufacture may be processed in batches when, for example, a plurality of aerosol generating articles 2 is manufactured simultaneously. When the aerosol generating article 2 is manufactured sequentially, predetermined continuous manufacture may be achieved.

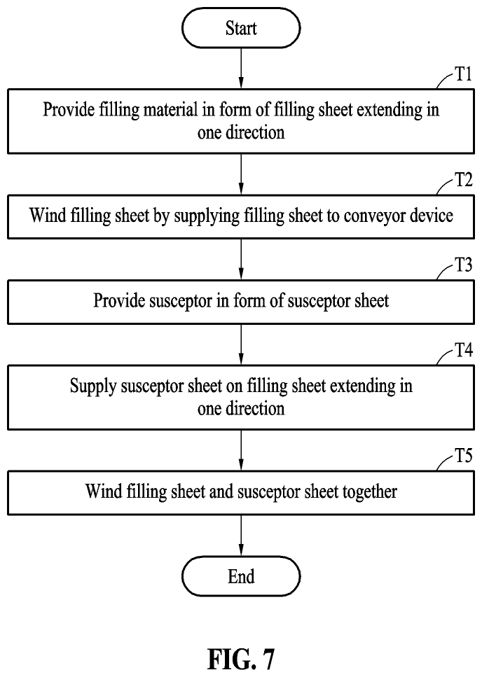

FIG. 7 is a flow chart of a method of manufacturing the aerosol generating article 2 according to an embodiment.

Referring to FIG. 7, according to an embodiment, the method of manufacturing the aerosol generating article 2 may include operation T1 of providing the filling material m in a form of a filling sheet extending in one direction, operation T2 of winding the filling sheet by supplying the filling sheet to a conveyor device, operation T3 of providing the susceptor 23 in a form of a susceptor sheet, operation T4 of supplying the susceptor sheet on the filling sheet extending in one direction, and operation T5 of winding the filling sheet and the susceptor sheet together.

In an embodiment, the filling material may be cut tobacco leaves and may be provided in a form of a continuous filling sheet (e.g., tobacco sheet) extending in one direction.

Operation T1 of providing the filling material m in the form of the filling sheet extending in one direction may include manufacturing and providing the filling material m in the form of the above-mentioned tobacco sheet. In operation T2, the filling material m provided in the form of the tobacco sheet, may be supplied on the conveyor device and wound.

In an embodiment, operation T3 of providing the susceptor 23 in the form of the susceptor sheet, desirably, may be an operation of providing the cylindrical susceptor 23 in an unfolded form. In operation T4, while the filling sheet (e.g., the filling material provided in the form of the tobacco sheet) is being wound, the susceptor sheet may be placed on the filling sheet such that the filling sheet and the susceptor sheet are wound together. The susceptor sheet may be placed on the filling sheet in the middle of a process of winding the filling sheet such that the susceptor sheet is disposed in the filling material m in a cylindrical shape or a cylindrical-like shape.

While the embodiments are described with reference to drawings, it will be apparent to one of ordinary skill in the art that various alterations and modifications in form and details may be made to these embodiments without departing from the spirit and scope of the claims and their equivalents. For example, suitable results may be achieved if the described techniques are performed in a different order and/or if components in a described system, architecture, device, or circuit are combined in a different manner and/or replaced or supplemented by other components or their equivalents.

Therefore, other implementations, other embodiments, and equivalents of the claims are within the scope of the following claims.

1. An aerosol generating article comprising:
a first segment comprising:
a filling material; and
a susceptor disposed to enclose a portion of the filling material and be enclosed by another portion of the filling material; and
a second segment disposed next to the first segment along a lengthwise direction of the aerosol generating article.

2. The aerosol generating article of claim 1, wherein
the susceptor comprises an inner surface facing a center of the first segment, and an outer surface opposite to the inner surface.

3. The aerosol generating article of claim 2, wherein the susceptor has a cylindrical shape.

4. The aerosol generating article of claim 3, wherein a radius of the cylindrical shape of the susceptor is greater than a half of a radius of the first segment and less than the radius of the first segment.

5. The aerosol generating article of claim 3, wherein
the susceptor comprises a first susceptor and a second susceptor,
the first susceptor has a cylindrical shape with a first radius, and the second susceptor has a cylindrical shape with a second radius, and
the second radius is greater than the first radius.

6. The aerosol generating article of claim 5, wherein the cylindrical shape of the first susceptor and the cylindrical shape of the second susceptor are concentric.

7. The aerosol generating article of claim 5, wherein
the susceptor further comprises a third susceptor,
the third susceptor has a cylindrical shape with a third radius, and
the third radius is greater than the second radius.

8. The aerosol generating article of claim 1, wherein the filling material comprises:
a medium; and
a thermally conductive powdered material mixed with the medium.

9. The aerosol generating article of claim 8, wherein the powdered material comprises at least one of aluminum, gold, iron, nickel, cobalt, conductive carbon, graphite, mild steel, stainless steel, copper, and bronze.

10. The aerosol generating article of claim 1, wherein the susceptor comprises at least one of aluminum, gold, iron, nickel, cobalt, conductive carbon, graphite, mild steel, stainless steel, copper, and bronze.

11. An aerosol generating system comprising:
an aerosol generating article comprising:
a first segment comprising:
a filling material; and
a susceptor disposed to enclose a portion of the filling material and be enclosed by another portion of the filling material; and
a second segment disposed next to the first segment along a lengthwise direction of the aerosol generating article; and
an aerosol generating device comprising an article insertion portion configured to accommodate the aerosol generating article, a battery, and a coil,
wherein the coil is configured to generate a variable magnetic field by receiving power from the battery, and the susceptor is configured to generate heat by the variable magnetic field.

12. A method of manufacturing the aerosol generating article of claim 1, the method comprising:
providing the aerosol generating article comprising the first segment filled with the filling material;
providing the susceptor;
positioning the susceptor and the aerosol generating article such that the susceptor is aligned with an end of the first segment; and
pushing the susceptor into the first segment.

13. A method of manufacturing the aerosol generating article of claim 1, the method comprising:
providing the filling material in a form of a filling sheet extending in one direction;
winding the filling sheet by supplying the filling sheet to a conveyor device;
providing the susceptor in a form of a susceptor sheet;
placing the susceptor sheet on the filling sheet; and
winding the filling sheet and the susceptor sheet together.
